(19) United States
(12) Patent Application Publication
(10) Pub. No.: US 2026/0147256 A1
(43) Pub. Date: May 28, 2026

(54) Low/No Glow IR Selection Implementations

(71) Applicant: Deer Management Systems, LLC, Caledonia, MN (US)

(72) Inventors: Jeffrey B. Peel, Decorah, IA (US); Mario Bonardi, Billings, MT (US); Jesse Mills, Palisade, CO (US); Orrin Bigelow, Pohoa, HI (US)

(21) Appl. No.: 19/357,772

(22) Filed: Oct. 14, 2025

Related U.S. Application Data
(60) Provisional application No. 63/726,113, filed on Nov. 27, 2024.

(51) Int. Cl. G03B 15/05; F21K 5/06; H04N 23/56; H04N 23/74

(52) U.S. Cl. CPC G03B 15/05; G03B 15/0442; H04N 23/56; H04N 23/74; G03B 2215/0567

(57) ABSTRACT

A camera includes an image sensor configured to capture an image of a target subject and a flash device configured to selectively illuminate the target subject with low-glow infrared light or no-glow infrared light. The flash device includes a set of first illumination devices that emit the low-glow infrared light and a set of second illumination devices that emit the no-glow infrared light. Each first illumination device includes a low-glow light-emitting diode (LED) that emits low-glow infrared light having a wavelength of about 730 nanometers to about 880 nanometers. Each second illumination device includes a no-glow LED that emits no-glow infrared light having a wavelength of about 940 nanometers or greater.

### CROSS-REFERENCE TO RELATED APPLICATIONS

The present application claims benefit of and priority to U.S. Provisional Application No. 63/726,113, filed Nov. 27, 2024, the contents of which is hereby incorporated herein by reference in its entirety.

### TECHNICAL FIELD

Aspects of the present disclosure relate to cameras and image capturing devices and more specifically to flash devices of such cameras and image capturing devices.

### BACKGROUND

Trail cameras and surveillance cameras are often mounted to trees, buildings, poles, or other structures so as to capture still images and/or video clips of wildlife and/or human activity within the field of view of the camera. In order to capture nighttime and/or low light wildlife and/or human activity, cameras may be equipped with an infrared flash device that emits an infrared strobe or infrared flash that illuminates wildlife, human activity, and/or surrounding area in the camera's field of view. The infrared illumination provided by such infrared strobe or flash may permit the camera to capture still images and/or video (i.e., a temporal series of still images) of wildlife and/or human activity in low light or no light ambient conditions.

To this end, cameras may include either a low-glow flash device or a no-glow flash device that emits infrared strobes having a wavelength greater than the wavelengths of light that are typically observable to humans (i.e., the visible light waveband). In particular, a low-glow flash device includes one or more low-glow light sources (e.g., low-glow light-emitting diodes) that are designed to emit infrared light or an infrared strobe having an 850 nanometer wavelength. Conversely, a no-glow infrared flash device includes one or more no-glow light sources (e.g., no-glow light-emitting diodes) that are designed to emit infrared light or an infrared strobe having a 940 nm wavelength. The 850 nm wavelength of the low-glow light sources is closer to the visible light waveband than the 940 nm wavelength of the no-glow light sources. Due to its closer proximity to the visible light waveband, when a low-glow flash device emits an infrared strobe, most humans are able to observe a red glow emanating from its low-glow light sources. Conversely, when a no-glow infrared flash device emits an infrared strobe, most humans are unable to observe a glow emanating from the no-glow light sources or, at the very least, any such observable glow is less pronounced than that of the low-glow light sources.

Thus, a no-glow flash device may be preferred to a low-glow flash device from the standpoint of avoiding detection and/or otherwise disturbing wildlife and/or humans being captured by the camera. However, while helpful from the standpoint of detection avoidance, the no-glow flash device typically causes the camera to capture still images and/or video having less contrast and less detail than images captured using a low-glow flash device. Thus, depending upon the intended usage of the camera, one may deploy a camera having a no-glow flash device, deploy a camera having a low-glow flash device, or may simply accept that the camera on hand may not have the most suitable flash device for the intended use.

Further limitations and disadvantages of conventional and traditional approaches will become apparent to one of skill in the art, through comparison of such approaches with some aspects of the present disclosure as set forth in the remainder of the present application with reference to the drawings.

### BRIEF SUMMARY OF THE DISCLOSURE

Shown in and/or described in connection with at least one of the figures, and set forth more completely in the claims, are flash devices having both low-glow light sources and no-glow light sources. Such flash devices may selectively emit infrared light and/or infrared strobes using either its low-glow light sources or its no-glow light sources. In this manner, the flash devices may provide a greater selection of illumination choices. Cameras, which incorporate such flash devices, may be suitable for a wider range of use cases than cameras having only a low-glow flash device or a no-glow flash device.

These and other advantages, aspects, and novel features of the present disclosure, as well as details of illustrated embodiments thereof, will be more fully understood from the following description and drawings.

### BRIEF DESCRIPTION OF THE DRAWINGS

Various features and advantages of the present disclosure may be more readily understood with reference to the following detailed description taken in conjunction with the accompanying drawings, wherein like reference numerals designate like structural elements.

FIG. 1 depicts a block diagram of a camera having a flash device in accordance with various aspects of the present disclosure.

FIG. 2 depicts an embodiment of a flash device suitable for the camera of FIG. 1, which includes a switch for selecting between two sets of illumination devices.

FIG. 3 depicts an embodiment of a flash device suitable for the camera of FIG. 1, which includes a separate driver circuit for each set of illumination devices.

FIG. 4 depicts an embodiment of a flash device suitable for the camera of FIG. 1, which includes an opaque cover that selectively blocks light emitted by one of two sets of illumination devices.

FIG. 5 depicts an embodiment of a flash device suitable for the camera of FIG. 1, in which sets of illumination devices are mounted to opposite sides of a circuit board.

FIG. 6 depicts an embodiment of a flash device suitable for the camera of FIG. 1, which includes an shutter to selectively block light emitted by one of two sets of illumination devices.

### DESCRIPTION

The present disclosure is directed to a flash device with a selectable flash mode and cameras that include such flash devices. In various embodiments, the flash device includes one or more first illumination devices and one or more second illumination devices. The first illumination devices have different illumination characteristics than the second illumination devices. In some embodiments, the first illumination devices comprise low-glow light sources such as low-glow light-emitting diodes (LEDs) and the second illumination devices comprise no-glow light sources such as low-glow LEDs. Based on a selected flash mode, the flash device emits infrared light and/or an infrared strobe using either the one or more first illuminating devices or the one or more second illuminating devices. In various embodiments, a user may manually select or otherwise set the flash mode of the flash device. In various embodiments, a controller may dynamically set or change the flash mode of the flash device via one or more control signals.

More specifically, the flash device, based on one or more user selections and associated control signals, may emit a no-glow strobe or a low-glow strobe. The no-glow strobe may comprise a pulse of infrared light having a wavelength of about 940 nm or greater. The low-glow strobe may comprise a pulse of infrared light having a wavelength of about 730 nm to about 880 nm. In either case, the duration of the pulse of light may be one second or less. In some embodiments, the flash device may be configured to emit a series of infrared strobes or emit light of sustained durations (e.g., greater than ten seconds, greater than 20 seconds, etc.) so as to permit capturing a temporal series of still images or video.

The figures illustrate a general manner of construction. Descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

Also, any numerical range recited herein is intended to include all sub-ranges subsumed therein. For example, a range of “1 to 10” is intended to include any and all sub-ranges between and including the recited minimum value of 1 and the recited maximum value of 10, that is, all sub-ranges beginning with a minimum value equal to or greater than 1 and ending with a maximum value equal to or less than 10, and all sub-ranges in-between, e.g., 1 to 6.3, or 5.5 to 10, or 2.7 to 6.1.

Further, the term “about” when used in with a numerical value or a numerical range is intended to account for small fluctuations due to manufacturing tolerances and/or environmental effects. For example, nominal values may fluctuate due to thermal effects resulting from operation and/or the surrounding ambient temperature. Such fluctuations are expected to be less than ±5% the nominal value.

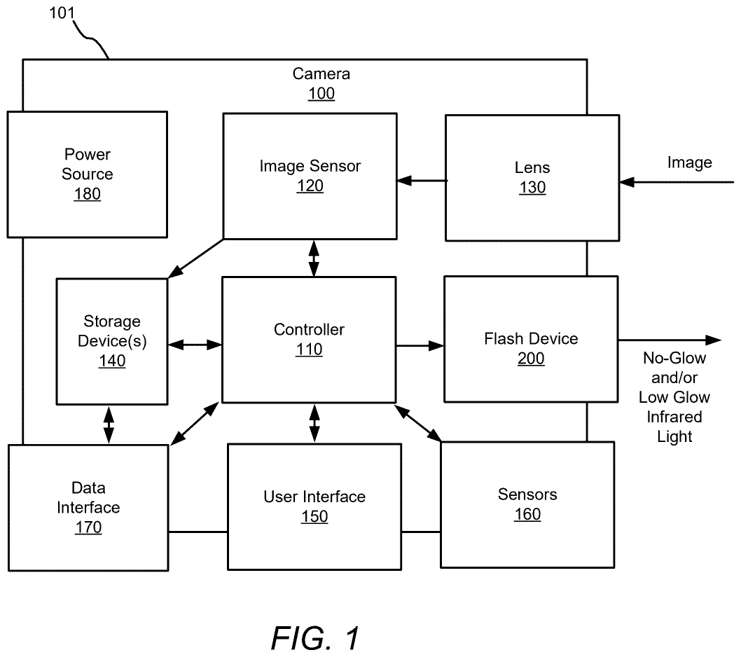

Referring to FIG. 1, a block diagram is shown of a camera 100 having a flash device 200 in accordance with various aspects of the present disclosure. In particular, the camera 100 may include a housing 101 that houses a controller 110, an image sensor 120, one or more autofocus lenses 130, a storage device 140, a user interface 150, one or more sensors 160, a data interface 170, a power source 180, and the flash device 200.

The controller 110 may comprise digital and/or analog circuitry configured to control the operation of the other camera components. To this end, the controller 110 may include one or more of a general purpose processor, a microcontroller, a field programmable gate array, and/or analog components such as comparators, transistors, etc. coupled to the other camera components so as to monitor and control their operation. Moreover, the controller 110 may control and monitor such other components as a result of its execution of one or more firmware routines, software routines, and/or operating system routines.

The controller 110 may be coupled to other components of the camera 100 via one or more buses, signal lines, etc. Via such connections, the controller 110 may receive data and/or status signals from the other components. Further, the controller 110 may provide data and/or control signals to the other components via which the controller 110 may control the operation of such components. For example, the controller 110 may generate one or more control signals that configure the flash device 200 with a flash mode of operation (e.g., a low-glow flash mode, or a no-glow flash mode). The controller 110 may further generate one or more control signals that cause the flash device 200 to emit light or emit a flash of light using a selected mode of operation.

The image sensor 120 may photoelectrically convert image light received via the one or more autofocus lenses 130 to digital image data and direct such digital image data to the storage device 140. To this end, the image sensor 120 may include one or more CMOS image sensors. Such CMOS image sensors may be collectively configured to capture images of daytime targets as well as nighttime targets illuminated via the low-glow flash mode or the no-glow flash mode of the flash device 200.

The storage device 140 may store data, firmware, digital pictures, digital videos, camera settings, sensor data, etc. In various embodiments, all or some of the data storage provided by the storage device 140 may be integrated with or otherwise provided by controller 110. Alternatively or in addition to storage of the controller 110, the storage device 140 may include one or more volatile memory devices and/or non-volatile memory devices.

The user interface 150 may include one or more user input devices such as push buttons, switches, touch pads, etc. via which a user may specify operating parameters of the camera 100. The user interface 150 may also include one or more user output devices such as lights, LED's, a liquid crystal display, audio speakers, video displays, etc. that convey various aspects of the camera's operation to a user. In various embodiments, user input devices and user output devices of the user interface 150 may provide a user with the ability to configure the mode of operation of the flash device 200. For example, as user may configure the camera 100 and its flash device 200 to operate in a low-glow mode flash mode or a no-glow flash mode. After such configuration, the camera 100 may capture subsequent images via the selected flash mode.

In some embodiments, the user interface 150 may provide a user with the ability to specify parameters for when each flash mode is to be used. Thus, after such configuration, the camera 100 may not simply subsequently capture images based on a fixed flash mode, but may capture images using a flash mode selected based on the sensed environment and the specified parameters. Thus, based on signals from sensors 160, the controller 110 may capture some images using the no-glow flash mode of the flash device 200 and capture other images using the low-glow flash mode of the flash device 200. In this manner, the camera 100 may adapt the flash mode in real-time based information received from the sensors 160 and/or parameters specified by the user.

The one or more sensors 160 may include a motion sensor for detecting motion of a target object (e.g., wildlife, human, etc.), a temperature sensor for sensing the ambient temperature, wind sensors for detecting a wind direction, ambient light sensors, and/or other sensors. The one or more sensors 160 may provide the controller 110 with status signals that are indicative of or otherwise representative of the sensed phenomena. Based on such status signals, the controller 110 may control or adjust the operation of one or more other components. For example, based on such status signals, the controller 110 may trigger the flash device 200 and capture still images and/or video images via the one or more autofocus lenses 130 and image sensor 120. Moreover, the controller 110 may adjust the operation of the flash based on such status signals. For example, the controller 110 may capture images without emitting a light from the flash device 200 when there is sufficient ambient light.

The data interface 170 may include various wired communication interfaces (e.g., USB interface, serial interface, Ethernet, etc.) suitable for transferring captured images from the storage device 140 of the camera 100 to an external device such as a desktop computer, laptop computer, hand-held computer, smartphone, etc. Further, the data interface 170 may include various wireless communication interfaces (e.g., cellular network interfaces, Wi-Fi interfaces, etc.) suitable for transferring captured images from the storage device 140 of the camera 100 to an external device such as desktop computer, laptop computer, hand-held computer, smartphone, etc. In additional to providing interfaces for transferring images from the storage device 140 to an external device, the data interface 170 may further permit controlling, configuring, and/or programming operation of the camera 100 from an external device via its wired and/or wireless communication interfaces. Further, the data interface 170 may provide camera status and other information gathered by the one or more sensors 160 to an external device via its wired and/or wireless communication interfaces.

The power source 180 may include one or more rechargeable batteries and/or one or more non-rechargeable batteries. In some embodiments, the power source 180 may include one or more lithium ion battery packs, alkaline battery packs, lithium polymer battery packs, Nickle-Metal Hydride (Ni-MH) battery packs, and/or battery packs of some other chemistry. In other embodiments, the power source 180 may be comprised of external DC power sources and/or DC power sources generated from AC sources, such as a wall outlet. The power source 180 may power the camera 100 and its respective components including the controller 110, the image sensor 120, the one or more autofocus lenses 130, the storage device 140, the user interface 150, the one or more sensors 160, and the data interface 170. The power source 180 may additionally power the one or more components of the flash device 200.

In general, the camera 100 may capture still images and/or video by activating the flash device 200 and causing the one or more autofocus lenses 130 to focus light reflected by the target subject (e.g., wildlife, a human, etc.), which includes a portion of the light emitted by the flash device 200, onto a light-sensing array of the image sensor 120. The light-sensing array of the image sensor 120 may convert the focused light into a digital image representation of the target subject. The digital image representation may then be stored by the storage device 140 for further presentation via the user interface 150 and/or retrieval via the data interface 170. Such operation may occur under the control of the controller 110. Moreover, the controller 110 may determine to active the flash device 200 and capture images in response to various trigger events that the controller 110 detects via status signals of the one or more sensors 160.

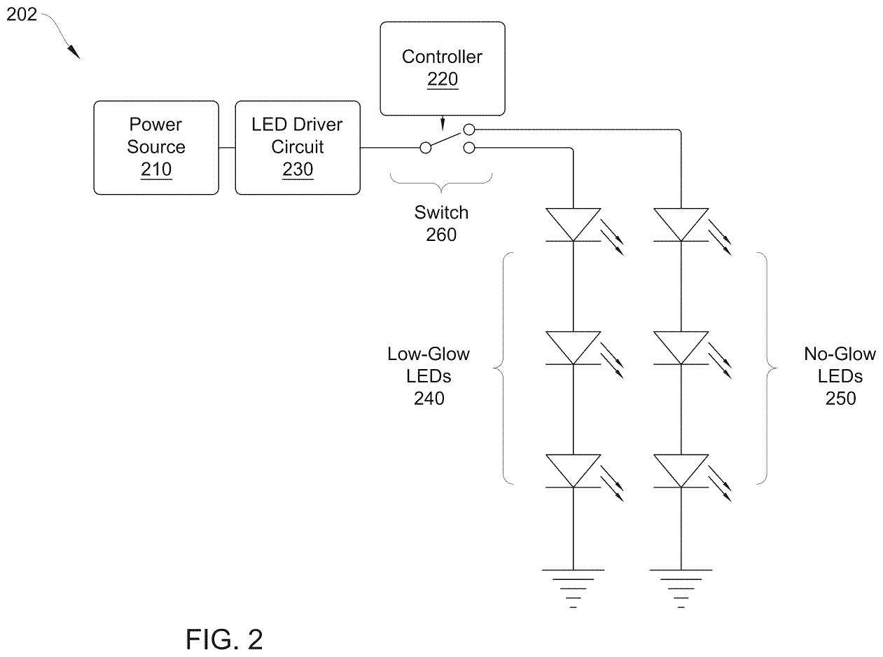

Referring now to FIG. 2, a diagram of a flash device 202 is shown. In some embodiments, the flash device 202 may be integrated into a camera and thus used to implement the flash device 200 of the camera 100 shown in FIG. 1. In other embodiments, the flash device 202 may be standalone external device, that may be operatively coupled to a camera (e.g., via an interface of the data interface 170).

As shown, the flash device 202 may include a power source 210, a controller 220, a driver circuit 230, a set of first illumination devices 240, a set of second illumination devices 250, and a switch 260.

In general, the power source 210 may be implemented in a manner similar to the power source 180 of the camera 100. For example, the power source 180 may include one or more rechargeable batteries and/or one or more non-rechargeable batteries. In some embodiments, the power source 210 may include one or more lithium ion battery packs. In some embodiments, the power source 210 may include one or more alkaline battery packs. The power source 210 may power the flash device 202 and its respective components including the controller 220, the driver circuit 230, the set of first illumination devices 240, the set of second illumination devices 250, and the switch 260.

In some embodiments, the flash device 202 may include its own power source 210 that is separate from the power source 180 of the camera 100. In other embodiments, the camera 100 and the flash device 202 may share the same power source. For example, a single set of rechargeable batteries may power the camera 100 and the flash device 202. In yet other embodiments, the power source 180 of the camera 100 and the power source 210 of the flash device 202 may share one or more other components. For example, the power source 180 and the power source 210 may share recharging hardware thus permitting recharging of the power source 180 and the power source 210 via a single external electrical connection.

In general, the controller 220 may be implemented in a manner similar to the controller 110 of the camera 100. For example, the controller 220 may comprise digital and/or analog circuitry configured to control the operation of the other flash device components. To this end, the controller 220 may include one or more of a general purpose processor, a microcontroller, a field programmable gate array, and/or analog components such as comparators, transistors, etc. coupled to the other flash device components so as to monitor and control their operation. Moreover, the controller 220 may control and monitor such other components as a result of its execution of one or more firmware routines, software routines, and/or operating system routines.

The controller 220 may be coupled to other components of the flash device 202 via one or more buses, signal lines, etc. Via such connections, the controller 220 may receive data and/or status signals from the other components. Further, the controller 220 may provide data and/or control signals to the other components via which the controller 220 may control the operation of such components. For example, the controller 220 may generate one or more control signals that configure the flash device 202 with a flash mode of operation (e.g., a low-glow flash mode, or a no-glow flash mode). The controller 220 may further generate one or more control signals that cause the flash device 202 to emit light or emit a flash of light using a selected mode of operation.

In some embodiments, the flash device 202 may include its own controller 220 that is separate from the controller 110 of the camera 100. In other embodiments, the camera 100 and the flash device 202 may share the same controller. In yet other embodiments, the controller 110 of the camera 100 and the controller 220 of the flash device 202 may share one or more components.

The driver circuit 230 may condition, regulate, convert, and/or otherwise deliver electrical power provided by the power source 180 of the camera 100 and/or the power source 210 of the flash device 202 to a form suitable for powering the set of first illumination devices 240 and the set of second illumination devices 250. To this end, the driver circuit 230 may include a switched mode converter, a linear low-dropout (LDO) regulator, or simply a resistor designed to properly convert the electrical power of the power source 180, 210 for the set of first illumination devices 240 and the set of second illumination devices 250.

The set of first illumination devices 240 may include one or more first illumination devices 240. In various embodiments, each first illumination device 240 may have similar illumination characteristics. For example, each first illumination device 240 may comprise a low-glow light source such as a low-glow light-emitting diodes (LED) that is designed to emit low-glow infrared light. More specifically, each low-glow light source may be designed to emit light having a wavelength of about 730 nm to about 880 nm.

In some embodiments, the controllers 110, 220, the driver circuit 230, and/or the switch 260 may control the duration of light emitted by the first illumination devices 240. For example, such components may cause the first illumination devices 240 to emit a series of low-glow strobes or emit low-glow light for a sustained period of time such as greater than ten seconds, greater than 20 seconds, etc. In some embodiments, the duration of the emitted low-glow strobes and/or the duration of the emitted low-glow light may be configurable via the user interface 150 and/or controlled by the controllers 110, 220.

Similarly, the set of second illumination devices 250 may include one or more second illumination devices 250. In various embodiments, each second illumination device 250 may have similar illumination characteristics, but differ from the illumination characteristics of the first illumination devices 240. For example, each second illumination device 250 may comprise a no-glow light source such as a no-glow LED designed to emit no-glow infrared light. More specifically, each no-glow light source may be designed to emit a flash or strobe of light having a wavelength of about 940 nm or greater.

In some embodiments, the controllers 110, 220, the driver circuit 230, and/or the switch 260 may also control the duration of light emitted by the second illumination devices 250. For example, such components may cause the second illumination devices 250 to emit a series of no-glow strobes or emit no-glow light for a sustained period of time such as greater than ten seconds, greater than 20 seconds, etc. In some embodiments, the duration of the emitted no-glow strobes and/or the duration of the emitted no-glow light may be configurable via the user interface 150 and/or controlled by the controllers 110, 220.

As shown in FIG. 2, the first illumination devices 240 are coupled in series between the switch 260 and ground. Similarly, the second illumination devices 250 are coupled in series between the switch 260 and ground. However, the illumination devices 240, 250 may be arranged in any manner of series and/or parallel configurations that best suits the driver circuit 230 and the power source 180, 210 being used.

The switch 260 may selectively couple, based on one or more control signals from the controller 110 and/or the controller 220, the first illumination devices 240 or the second illumination devices 250 to the driver circuit 230. To this end, the switch 260 may include two analog switch circuits, a single one input, two output switch (as shown), and/or other switching components suitable selectively funneling power from the driver circuit 230 to either the first illumination devices 240 or the second illumination devices 250. In particular, the switch 260 may comprise a mechanical switch (e.g., a reed switch), a semiconductor-based switch (e.g., a MOSFET, or other transistor), or other type of switching component. Further, the switch 260 may be coupled to the illumination devices 240, 250 as a “high side” switch in which anodes of the illumination devices 240, 250 are coupled to the driver circuit 230 via the switch 260 and the cathodes of the illumination devices 240, 250 are coupled to ground as shown. Alternatively, the switch 260 may be coupled to the illumination devices 240, 250 as a “low side” switch in which the anodes of the illumination devices 240, 250 are coupled to the driver circuit 230 and the cathodes of the illumination devices 240, 250 are coupled to ground via the switch 260.

Via the switch 260, the controller 110 and/or the controller 220 may specify a flash mode for the flash device 202. In particular, the flash device 202 may be configured for a low-glow flash mode in which the flash device 202 emits low-glow infrared light using the set of first illumination devices 240. Alternatively, the flash device 202 may be configured for a no-glow flash mode in which the flash device 202 emits no-glow infrared light using the set of second illumination devices 250. In various embodiments, a user may manually select or otherwise set the flash mode of the flash device 202. In various embodiments, the controller 110 and/or the controller 220 may dynamically set or change the flash mode of the flash device 202 via one or more control signals.

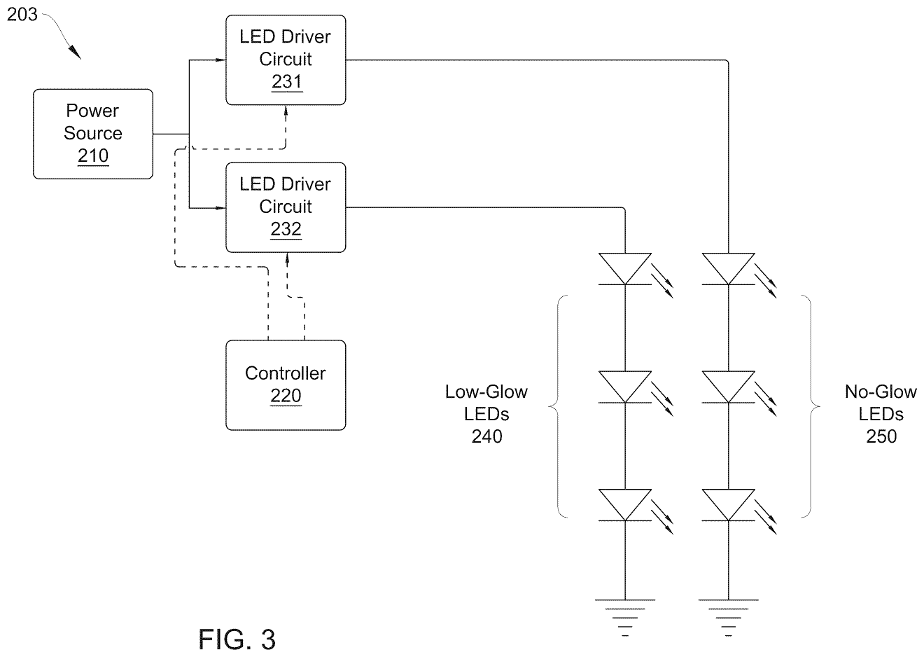

Referring now to FIG. 3, a diagram of a flash device 203 is shown. In some embodiments, the flash device 203 may be integrated into a camera and thus used to implement the flash device 200 of the camera 100 shown in FIG. 1. In other embodiments, the flash device 203 may be standalone external device, that may be operatively coupled to a camera (e.g., via an interface of the data interface 170).

As shown, the flash device 203 may include a power source 210, a controller 220, a first driver circuit 231, a second driver circuit 232, a set of first illumination devices 240, and a set of second illumination devices 250. In general, the power source 210, the controller 220, the set of first illumination devices 240, and the set of second illumination devices 250 of the flash device 203 may be implemented in the same manner or a similar manner to the controller 220, the set of first illumination devices 240, and the set of second illumination devices 250 of the flash device 202 of FIG. 2. As such, details of such components will not be repeated.

The first driver circuit 231 may condition, regulate, convert, and/or otherwise deliver electrical power provided by the power source 180 of the camera 100 and/or the power source 210 of the flash device 202 to a form suitable for powering the set of first illumination devices 240. Similarly, the second driver circuit 232 may condition, regulate, convert, and/or otherwise deliver electrical power provided by the power source 180 of the camera 100 and/or the power source 210 of the flash device 202 to a form suitable for powering the set of second illumination devices 250. To this end, each driver circuit 231, 232 may include a constant current controlled step down switching converter that delivers suitable power to its respective set of illuminations devices 240, 250 when enabled. Depending on battery voltages, forward voltages of the LEDs, and the series/parallel topology of the LEDs, the driver circuit 231, 232, may also be comprised of a step-up converter, a step-up/step down converter, and/or some other type converter.

In particular, each driver circuit 231, 232 comprises an enable input configured to receive an enable/disable control signal from the controller 110 and/or the controller 220. In this manner, the controller 110 and/or controller 220 may independently enable each driver circuit 232, 232 so as to selectively drive the set of first illumination devices 240 or the set of second illumination devices 250. For example, each driver circuit 231, 232 may comprise a logic pin that enables the respective driver circuit 231, 232 when a suitable enable signal (e.g., a logic high signal, a 3.3V signal, etc.) is applied to the logic pin. Conversely, the logic pin may disable the respective driver circuit 231, 232 when a suitable disable signal (e.g., a logic low signal, a 0V signal, etc.) is applied to the logic pin. In other embodiments, each driver circuit 231, 232 may each include a switch similar to switch 260 of FIG. 2 in the power path of the respective driver circuit 231, 232. Appropriate switching of such a switch may enable/disable the respective driver circuit 231, 232, thus permitting the selective driving and subsequent illumination of the illumination devices 240, 250.

Via the driver circuits 231, 232, the controller 110 and/or the controller 220 may specify a flash mode for the flash device 203. In particular, enabling the first driver circuit 231 and disabling the second driver circuit 232 may configure the flash device 203 for a low-glow flash mode in which the flash device 203 emits low-glow infrared light using the set of first illumination devices 240. Alternatively, disabling the first driver circuit 231 and enabling the second driver circuit 232 may configured the flash device 203 for a no-glow flash mode in which the flash device 203 emits no-glow infrared light using the set of second illumination devices 250. In various embodiments, a user may manually select or otherwise set the flash mode of the flash device 203. In various embodiments, the controller 110 and/or the controller 220 may dynamically set or change the flash mode of the flash device 203 via one or more control signals.

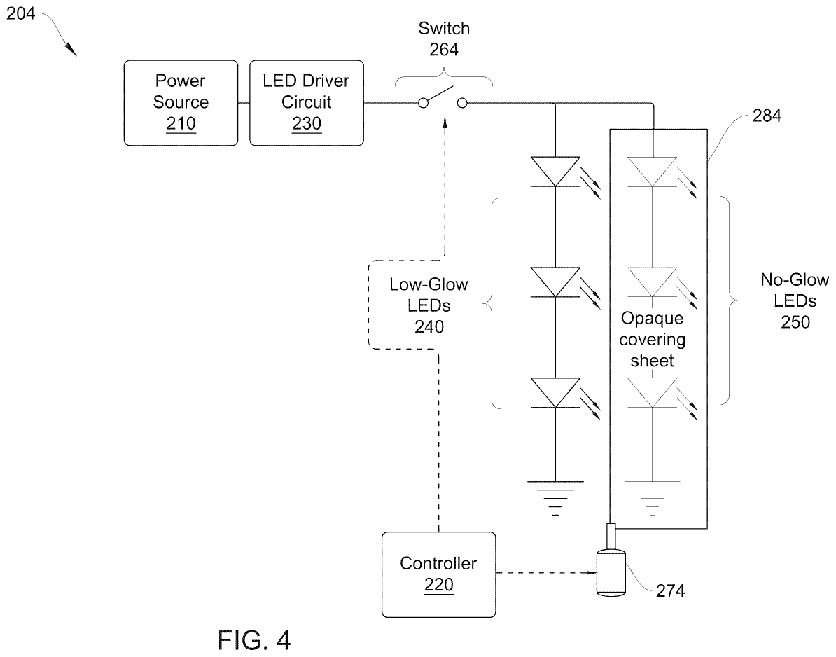

Referring now to FIG. 4, a diagram of a flash device 204 is shown. In some embodiments, the flash device 204 may be integrated into a camera and thus used to implement the flash device 200 of the camera 100 shown in FIG. 1. In other embodiments, the flash device 204 may be standalone external device, that may be operatively coupled to a camera (e.g., via an interface of the data interface 170).

As shown, the flash device 204 may include a power source 210, a controller 220, a driver circuit 230, a set of first illumination devices 240, a set of second illumination devices 250, a switch 264, an actuator 274, and one or more opaque covers 284. In general, the power source 210, the controller 220, the driver circuit 230, the set of first illumination devices 240, and the set of second illumination devices 250 of the flash device 203 may be implemented in the same manner or a similar manner to the controller 220, the driver circuit 230, the set of first illumination devices 240, and the set of second illumination devices 250 of the flash device 202 of FIG. 2. As such, details of such components will not be repeated.

Based on one or more control signals from the controller 110 and/or the controller 220, the switch 264 may either (i) couple both the set of first illumination devices 240 and the set of second illumination devices 250 to the driver circuit 230, or (ii) decouple both the set of first illumination devices 240 and the set of second illumination devices 250 from the driver circuit 230. Thus, unlike the flash device 202 of FIG. 2 and the flash device 203 of FIG. 3, the set of first illumination devices 240 and the set of second illumination devices 250 both emit their respective light regardless of which flash mode is selected. But, through mechanical means discussed below, only the desired light (e.g., low-glow strobe) for the selected flash mode is directed toward the field of view of the camera 100 and the undesired light (e.g., no-glow strobe) for the selected flash mode is either blocked or directed away from the field of view of the camera 100. In this manner, a target subject (e.g., the wildlife, human, etc.) is only illuminated with the desired light despite both types of light being emitted by the respective illumination devices 240, 250.

To this end, the switch 264 may include an analog switch circuit, a one input, one output switch (as shown), and/or other switching components suitable coupling/decoupling power from the driver circuit 230 to the first illumination devices 240 and the second illumination devices 250. In particular, the switch 264 may comprise a mechanical switch (e.g., a reed switch), a semiconductor-based switch (e.g., a MOSFET, or other transistor), or other type of switching component. Further, the switch 264 may be coupled to the illumination devices 240, 250 as a “high side” switch in which anodes of the illumination devices 240, 250 are coupled to the driver circuit 230 via the switch 264 and the cathodes of the illumination devices 240, 250 are coupled to ground as shown. Alternatively, the switch 264 may be coupled to the illumination devices 240, 250 as a “low side” switch in which the anodes of the illumination devices 240, 250 are coupled to the driver circuit 230 and the cathodes of the illumination devices 240, 250 are coupled to ground via the switch 264.

As noted, the flash device 204 of FIG. 4 generally differs from the flash device 202 of FIG. 2 and the flash device 203 of FIG. 3 in that the set of first illumination devices 240 and the set of second illumination devices 250 both emit their respective light regardless of which flash mode is selected. But, through mechanical means, the desired light is directed toward the field of view of the camera 100 and the undesired light is either blocked or directed away from the field of view of the camera 100. In this manner, the wildlife, human, etc. is only illuminated with the desired light (e.g., a low-glow strobe, or a no-glow strobe) despite both types of light being emitted by the respective illumination devices 240, 250.

To this end, the flash device 204 may include opaque cover 284 (e.g., a sheet of opaque material) that is coupled to the actuator 274. In particular, the opaque cover 284 covers the set of first illumination devices 240 when in a no-glow position and covers the set of second illumination devices 250 when in a low-glow position. The actuator 274, which may comprise a servomotor, a linear actuator, a rotary actuator, or one or more other electrically activated and/or electrically driven actuators, may physically position the opaque cover in either the low-glow position or the no-glow position based on one or more control signals. Thus, depending on the selected flash mode, the controller 110 and/or controller 220 may generate one or more control signals which cause the actuator 274 to position the opaque covers 284 such that it uncovers the illumination devices 240, 250 for the desired flash mode and covers the illumination devices 240, 250 for the undesired flash mode. More specifically, if the no-glow flash mode is selected, the controller 110 and/or controller 220 may generate one or more control signals which cause the actuator 274 to place the opaque cover 284 in the no-glow position which covers the set of first illumination devices 240 and uncovers the set of second illumination devices 250. Conversely, if the low-glow flash mode is selected, the controller 110 and/or controller 220 may generate one or more control signals which cause the actuator 274 to place the opaque covers 284 in the low-glow position which uncovers the set of first illumination devices 240 and covers the set of second illumination devices 250.

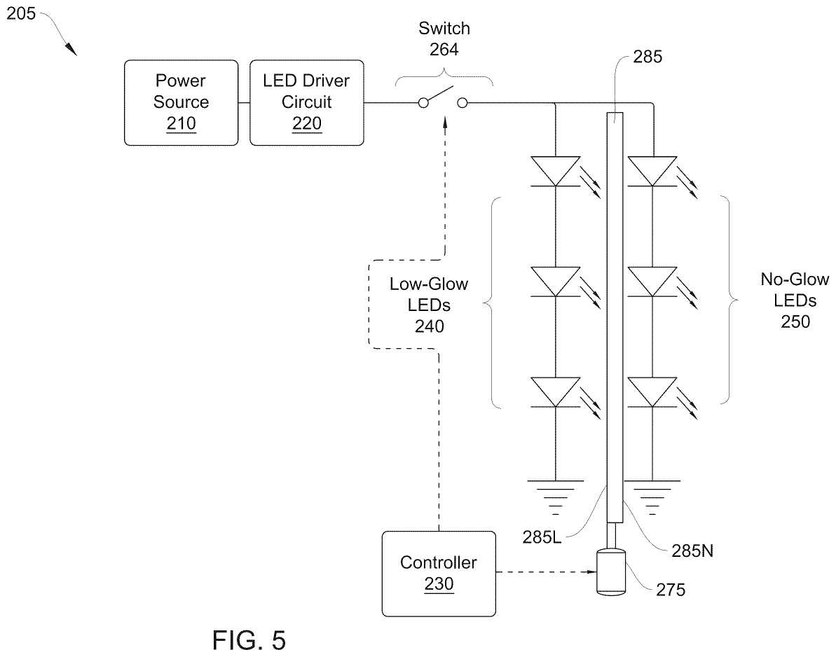

Referring now to FIG. 5, a diagram of a flash device 205 is shown. In some embodiments, the flash device 205 may be integrated into a camera and thus used to implement the flash device 200 of the camera 100 shown in FIG. 1. In other embodiments, the flash device 205 may be standalone external device, that may be operatively coupled to a camera (e.g., via an interface of the data interface 170).

As shown, the flash device 205 may include a power source 210, a controller 220, a driver circuit 230, a set of first illumination devices 240, a set of second illumination devices 250, a switch 264, an actuator 275, and a circuit board 285. In general, the power source 210, the controller 220, the driver circuit 230, the set of first illumination devices 240, the set of second illumination devices 250, and the switch 264 of the flash device 205 may be implemented in the same manner or a similar manner to the controller 220, the driver circuit 230, the set of first illumination devices 240, the set of second illumination devices 250, and the switch 264 of the flash device 204 of FIG. 4. As such, details of such components will not be repeated.

Similar to the flash device 204 of FIG. 4, both the set of first illumination devices 240 and the set of second illumination devices 250 of the flash device 205 emit their respective light regardless of which flash mode is selected. But, through mechanical means, the desired light is directed toward the field of view of the camera 100 and the undesired light is either blocked or directed away from the field of view of the camera 100. In this manner, the wildlife, human, etc. is only illuminated with the desired light (e.g., a low-glow strobe, or a no-glow strobe) despite both types of light being emitted by the respective illumination devices 240, 250.

To this end, the set of first illumination devices 240 of the flash device 205 may be mounted on a first side 285L of the circuit board 285 and the set of second illumination devices 250 of the flash device 205 may be mount on a second side 285N of the circuit board 285 that is opposite the first side 285L of the circuit board 285. In this manner, the circuit board 285 may permit the set of first illumination devices 240 to emit light away from the first side 285L of the circuit board 285 while at the same to blocking such light from reaching the second side 285N of the circuit board 285. Conversely, the circuit board 285 may permit the set of second illumination devices 250 to emit light away from the second side 285N of the circuit board 285 while at the same to blocking such light from reaching the first side 285L of the circuit board 285.

Similar to the actuator 274 of FIG. 4, the actuator 275 may comprise a servomotor, a linear actuator, a rotary actuator, or one or more other electrically activated and/or electrically driven actuators. Moreover, the actuator 275 may physically position, based on one or more control signals, the circuit board 285 such that either the set of first illumination devices 240 or the set of second illumination devices 250 illuminate the camera's field of view. In particular, depending on the selected flash mode, the controller 110 and/or controller 220 may generate one or more control signals which cause the actuator 275 to rotate or otherwise position the circuit board 285 such that either the first side 285L or the second side 285N faces the field of view of the camera 100. More specifically, if the low-glow flash mode is selected, the controller 110 and/or controller 220 may generate one or more control signals which cause the actuator 275 to rotate or otherwise position the circuit board 285 such that the first side 285L faces the camera's field of view and the second side 285N faces away from the camera's field of view. As a result of such facing, the low-glow infrared light of the set of first illumination devices 240 may illuminate the camera's field of view while the circuit board 285 blocks the no-glow infrared light from the camera's field of view. Conversely, if the no-glow flash mode is selected, the controller 110 and/or controller 220 may generate one or more control signals which cause the actuator 275 to rotate or otherwise position the circuit board 285 such that the second side 285N faces the camera's field of view and the first side 285L faces away from the camera's field of view. As a result of such facing, the no-glow infrared light of the set of second illumination devices 250 may illuminate the camera's field of view while the circuit board 285 blocks the low-glow infrared light from the camera's field of view.

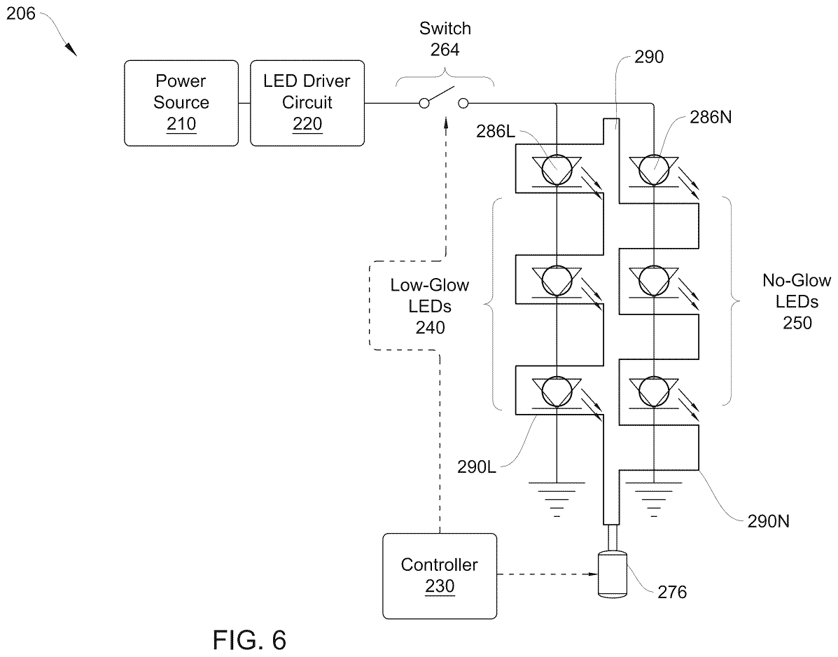

Referring now to FIG. 6, a diagram of a flash device 206 is shown. In some embodiments, the flash device 206 may be integrated into a camera and thus used to implement the flash device 200 of the camera 100 shown in FIG. 1. In other embodiments, the flash device 206 may be standalone external device, that may be operatively coupled to a camera (e.g., via an interface of the data interface 170).

As shown, the flash device 206 may include a power source 210, a controller 220, a driver circuit 230, a set of first illumination devices 240, a set of second illumination devices 250, a switch 264, an actuator 276, a set of first oculi 286L, a set of second oculi 286L, and one or more shutters 290. In general, the power source 210, the controller 220, the driver circuit 230, the set of first illumination devices 240, the set of second illumination devices 250, and the switch 264 of the flash device 205 may be implemented in the same manner or a similar manner to the controller 220, the driver circuit 230, the set of first illumination devices 240, the set of second illumination devices 250, and the switch 264 of the flash device 204 of FIG. 4. As such, details of such components will not be repeated.

Similar to the flash device 204 of FIG. 4, both the set of first illumination devices 240 and the set of second illumination devices 250 of the flash device 206 emit their respective light regardless of which flash mode is selected. But, through mechanical means, the desired light is directed toward the field of view of the camera 100 and the undesired light is either blocked or directed away from the field of view of the camera 100. In this manner, the wildlife, human, etc. is only illuminated with the desired light (e.g., a low-glow strobe, or a no-glow strobe) despite both types of light being emitted by the respective illumination devices 240, 250.

To this end, the set of first oculi 286L may be positioned or otherwise aligned with the set of first illumination devices 240 of the flash device 206 such that light emitted from the set of first illumination devices 240 passes through the set of first oculi 286L when illuminating the camera's field of view. Similarly, the set of second oculi 286N may be positioned or otherwise aligned with the set of second illumination devices 250 of the flash device 206 such that light emitted from the set of second illumination devices 250 passes through the set of first oculi 286L when illuminating the camera's field of view.

The shutter 290 may be coupled to the actuator 276. Similar to the actuator 274 of FIG. 4, the actuator 276 may comprise a servomotor, a linear actuator, a rotary actuator, or one or more other electrically activated and/or electrically driven actuators. Moreover, the actuator 276 may physically position the shutter 290 based on one or more control signals. In particular, the actuator 276 may slide or otherwise position the shutter 290 in a no-glow position, which covers or blocks the set of first oculi 286L and uncovers the set of second oculi 286N. Further, the actuator may slide or otherwise position the shutter 290 in a low-glow position, which uncovers the set of first oculi 286L and covers or blocks the set of second oculi 286N. Via such selective covering, light from the desired illumination devices 240, 250 for the selected flash mode may illuminate the camera's field of view while light from the undesired illumination devices 240, 250 for the selected flash mode is blocked by the shutter 290 from the camera's field of view.

To this end, the shutter 290 in some embodiments may include a set of first tabs 290L configured to block or cover the set of first oculi 286L and a set of second tabs 290N configured to block or cover the set of second oculi 286N. In some embodiments, the set of first oculi 286L may be vertically aligned with the set of second oculi 286N. In such embodiments, the set of first tabs 290L may be vertically offset from the set of second tabs 290N and the actuator 276 may vertically slide the shutter 290 in order to cover one set of oculi 286L, 286N and uncover the other set of oculi 286L, 286N. While FIG. 6 depicts the tabs 290L, 290N vertically offset and the oculi 286L, 286N vertically aligned, in some embodiments the tabs 290L, 290N may be vertically aligned and the oculi 286L, 286L vertically offset.

Thus, depending on the selected flash mode, the controller 110 and/or controller 220 may generate one or more control signals which cause the actuator 276 to slide or otherwise position the shutter 290 such that either the set of first oculi 286L or the set of second oculi 286N are covered by the shutter 290. More specifically, if the low-glow flash mode is selected, the controller 110 and/or controller 220 may generate one or more control signals which cause the actuator 276 to slide or otherwise place the shutter 290 in the low-glow position such that its tabs 290L uncover the set of first oculi 286L and its tabs 290N cover the set of second oculi 286N. As a result of such positioning of the shutter 290, the low-glow infrared light of the set of first illumination devices 240 may pass through the set of first oculi 286L and illuminate the camera's field of view while the shutter 290 blocks the no-glow infrared light from the camera's field of view. Conversely, if the no-glow flash mode is selected, the controller 110 and/or controller 220 may generate one or more control signals which cause the actuator 276 to slide or otherwise place the shutter 290 in the no-glow position such that its tabs 290L cover the set of first oculi 286L and its tabs 290N uncover the set of second oculi 286N. As a result of such positioning of the shutter 290, the no-glow infrared light of the set of second illumination devices 250 may pass through the set of second oculi 286N and illuminate the camera's field of view while the shutter 290 blocks the low-glow infrared light from the camera's field of view.

The present disclosure includes reference to certain examples, however, it will be understood by those skilled in the art that various changes may be made and equivalents may be substituted without departing from the scope of the disclosure. In addition, modifications may be made to the disclosed examples without departing from the scope of the present disclosure. Therefore, it is intended that the present disclosure not be limited to the examples disclosed, but that the disclosure will include all examples falling within the scope of the appended claims.

What is claimed is:

1. A camera, comprising:
an image sensor configured to capture an image of a target subject; and
a flash device configured to selectively illuminate the target subject with low-glow infrared light or no-glow infrared light.

2. The camera of claim 1, comprising a controller that causes the flash device to emit either the low-glow infrared light or the no-glow infrared light.

3. The camera of claim 1, wherein the flash device comprises:
one or more first illumination devices that emit the low-glow infrared light; and
one or more second illumination devices that emit the no-glow infrared light.

4. The camera of claim 3, wherein:
each of the one or more first illumination devices comprises a low-glow light-emitting diode (LED); and
each of the one or more second illumination devices comprises a no-glow LED.

5. The camera of claim 1, wherein:
the low-glow infrared light has a wavelength of about 850 nanometers; and
the no-glow infrared light has a wavelength of about 940 nanometers.

6. The camera of claim 1, wherein:
the low-glow infrared light has a wavelength of about 730 nanometers to about 880 nanometers; and
the no-glow infrared light has a wavelength of about 940 nanometers or greater.

7. The camera of claim 1, wherein the flash device comprises:
a set of first illumination devices that emit the low-glow infrared light;
a set of second illumination devices that emit the no-glow infrared light; and
a switch that selects the set of first illumination devices or the set of second illumination devices based on one or more control signals.

8. The camera of claim 1, wherein the flash device comprises:
a set of first illumination devices that emit the low-glow infrared light;
a set of second illumination devices that emit the no-glow infrared light;
an opaque cover having a no-glow position that covers the set of first illumination devices and a low-glow position that covers the set of second illumination devices; and
an actuator configured to physically position the opaque cover to either the low-glow position or the no-glow position based on one or more control signals.

9. The camera of claim 1, wherein the flash device comprises:
a set of first illumination devices that emit the low-glow infrared light;
a set of first oculi through which the set of first illumination devices emit the low-glow infrared light;
a set of second illumination devices that emit the no-glow infrared light;
a set of second oculi through which the set of second illumination devices emit the no-glow infrared light;
a shutter having a no-glow position that blocks the set of first oculi and a low-glow position that blocks the set of second oculi; and
an actuator configured to physically position the shutter to either the low-glow position or the no-glow position based on one or more control signals.

10. The camera of claim 1, wherein the flash device comprises:
a circuit board having a circuit board first side and a circuit board second side opposite the circuit board first side;
a set of first illumination devices mounted to the circuit board first side, wherein the set of first illuminations devices emit the low-glow infrared light;
a set of second illumination devices mounted to the circuit board second side, wherein the set of second illumination devices emit the no-glow infrared light; and
an actuator configured to physically rotate the circuit board to direct either the set of first illumination devices or the set of second illumination devices toward a field of view for the camera.

11. A flash device, comprising:
a set of first illumination devices that emit low-glow infrared light; and
a set of second illumination devices that emit no-glow infrared light.

12. The flash device of claim 11, comprising a controller that causes the flash device to emit either the low-glow infrared light of the set of first illumination devices or no-glow infrared light of the set of second illumination devices.

13. The flash device of claim 11, wherein:
each first illumination device of the set of first illumination devices comprises a low-glow light-emitting diode (LED); and
each second illumination device of the set of second illumination devices comprises a no-glow LED.

14. The flash device of claim 11, wherein:
the low-glow infrared light has a wavelength of about 850 nanometers; and
the no-glow infrared light has a wavelength of about 940 nanometers.

15. The flash device of claim 11, wherein:
the low-glow infrared light has a wavelength of about 730 nanometers to about 880 nanometers; and
the no-glow infrared light has a wavelength of about 940 nanometers or greater.

16. The flash device of claim 11, comprising a switch that selects and causes, based on one or more control signals, the set of first illumination devices to emit the low-glow infrared light or the set of second illumination devices to emit the no-glow infrared light.

17. The flash device of claim 11, comprising:
an opaque cover having a no-glow position that covers the set of first illumination devices and a low-glow position that covers the set of second illumination devices; and
an actuator configured to physically position the opaque cover to either the low-glow position or the no-glow position based on one or more control signals.

18. The flash device of claim 11, comprising:
a set of first oculi through which the set of first illumination devices emit the low-glow infrared light;
a set of second oculi through which the set of second illumination devices emit the no-glow infrared light;
a shutter having a no-glow position that blocks the set of first oculi and a low-glow position that blocks the set of second oculi; and
an actuator configured to physically position the shutter to either the low-glow position or the no-glow position based on one or more control signals.

19. The flash device of claim 18, wherein:
the shutter comprising a set of first tabs to block the set of first oculi and a set of second tabs to block the set of second oculi;
the set of first oculi are aligned with the set of second oculi in a first direction; and
the set of first tabs are offset from the set of second tabs in the first direction.

20. The flash device of claim 11, comprising:
a circuit board having a circuit board first side to which the set of first illumination devices are mount and a circuit board second side to which the set of second illumination devices are mounted; and
an actuator configured to physically rotate the circuit board to direct either the set of first illumination devices or the set of second illumination devices toward a field of view.
